(19) United States
(12) Patent Application Publication
(10) Pub. No.: US 2023/0351631 A1
(43) Pub. Date: Nov. 2, 2023

(54) INFORMATION PROCESSING APPARATUS, INFORMATION PROCESSING METHOD, AND COMPUTER-READABLE RECORDING MEDIUM

(71) Applicant: DENSO TEN Limited, Kobe-shi (JP)

(72) Inventors: Naoshi KAKITA, Kobe (JP); Koji OHNISHI, Kobe (JP); Takayuki OZASA, Kobe (JP)

(73) Assignee: DENSO TEN Limited, Kobe-shi (JP)

(21) Appl. No.: 17/942,305

(22) Filed: Sep. 12, 2022

(30) Foreign Application Priority Data
Apr. 28, 2022 (JP) 2022-075096

(51) Int. Cl. G06T 7/73; G06T 7/246

(52) U.S. Cl. CPC G06T 7/73; G06T 7/246; G06T 2207/30244; G06T 2207/30256; B60W 30/06

(57) ABSTRACT

An information processing apparatus according to the embodiment includes a control unit (corresponding to an example of a “controller”). The control unit performs attitude estimation processing to estimate the attitude of an onboard camera based on optical flows of feature points in a region of interest set in an image captured by the onboard camera. When the onboard camera is mounted in a first state, the control unit performs first attitude estimation processing using a first region of interest set in a rectangular shape, and, when the onboard camera is mounted in a second state, the control unit performs second attitude estimation processing using a second region of interest set in accordance with the shape of a road surface.

### CROSS-REFERENCE TO RELATED APPLICATION

This application is based upon and claims the benefit of priority of the prior Japanese Patent Application No. 2022-075096, filed on Apr. 28, 2022, the entire contents of which are incorporated herein by reference.

### FIELD

The embodiment discussed herein is directed to an information processing apparatus, an information processing method, and a computer-readable recording medium.

### BACKGROUND

The mounting position and attitude of onboard cameras can change due to unexpected contact or changes over time, resulting in errors from the initial calibration of the mounting. To detect this, conventional techniques have been known to estimate the attitude of an onboard camera on the basis of images captured by the onboard camera.

For example, the technique disclosed in Japanese Patent Application Laid-open No. 2021-086258 extracts feature points on a road surface from a rectangular region of interest (ROI) set in a captured image, and estimates the attitude of the onboard camera on the basis of optical flows indicating the motion of the feature points across frames.

On the basis of such optical flows, pairs of parallel line segments in a real space can be extracted to estimate the attitude (rotation angles of the pan, tilt, and roll axes) of the onboard camera by using, for example, the algorithm in [online], Keio University, [searched on Mar. 31, 2022], the Internet <URL: http://im-lab.net/artoolkit-overview/>.

However, there is room for further improvement in the aforementioned conventional techniques in order to improve the accuracy of attitude estimation of the onboard camera.

### SUMMARY

An information processing apparatus according to one aspect of embodiments includes a controller. The controller performs attitude estimation processing to estimate the attitude of an onboard camera based on optical flows of feature points in a region of interest set in an image captured by the onboard camera. When the onboard camera is mounted in a first state, the controller performs first attitude estimation processing using a first region of interest set in a rectangular shape, and, when the onboard camera is mounted in a second state, the controller performs second attitude estimation processing using a second region of interest set in accordance with the shape of a road surface.

### BRIEF DESCRIPTION OF DRAWINGS

FIG. 1 is an overview illustration (1) of an attitude estimation method according to an embodiment;

FIG. 2 is an overview illustration (2) of the attitude estimation method according to the embodiment;

FIG. 3 is an overview illustration (3) of the attitude estimation method according to the embodiment;

FIG. 4 is a block diagram illustrating an example configuration of an onboard device according to the embodiment;

FIG. 5 is an illustration (1) of a road surface ROI and a superimposed ROI;

FIG. 6 is an illustration (2) of the road surface ROI and the superimposed ROI;

FIG. 7 is a block diagram illustrating an example configuration of an attitude estimation unit; and

FIG. 8 is a flowchart illustrating a procedure performed by the onboard device according to the embodiment.

### DESCRIPTION OF EMBODIMENTS

An embodiment of an information processing apparatus, an information processing method, and a computer-readable recording medium disclosed in the present application will be described in detail below with reference to the accompanying drawings. The invention is not limited by the embodiment described below.

In the following, it will be assumed that the information processing apparatus according to the embodiment is an onboard device 10 installed in a vehicle. The onboard device 10 is, for example, a drive recorder. In the following, it will also be assumed that the information processing method according to the embodiment is an attitude estimation method of a camera 11 (see FIG. 4) provided on the onboard device 10.

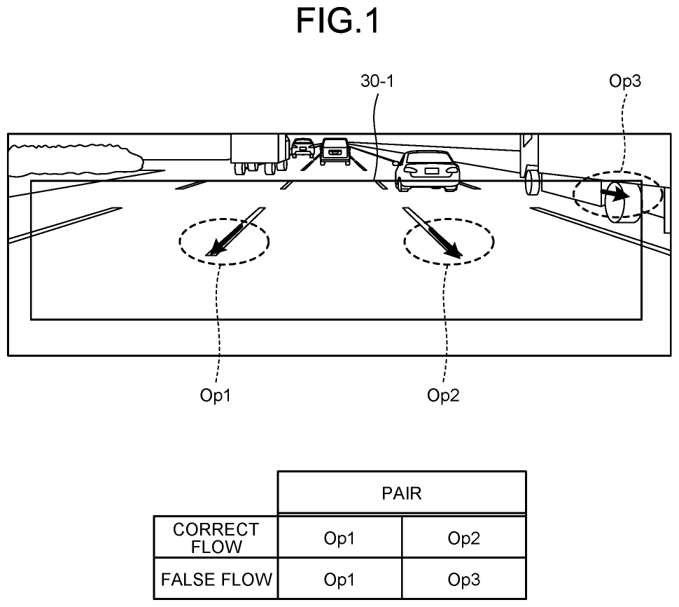

FIG. 1 to FIG. 3 are respectively overview illustrations (1) to (3) of the attitude estimation method according to the embodiment. First, the problem of the existing technology will be described more specifically prior to the description of the attitude estimation method according to the embodiment. FIG. 1 illustrates the content of the problem.

When the attitude of the camera 11 is estimated on the basis of optical flows of feature points on a road surface, the feature points on the road surface to be extracted include the corner portions of road surface markings such as lanes.

However, as illustrated in FIG. 1, for example, the lane markers in the captured image appear to converge toward the vanishing point in perspective. Thus, when a rectangular ROI (hereinafter referred to as a “rectangular ROI 30-1”) is used, the feature points of three-dimensional objects other than the road surface are more likely to be extracted in the upper left and upper right of the rectangular ROI 30-1.

FIG. 1 illustrates an example in which optical flows Op1 and Op2 are extracted on the basis of the feature points on the road surface, and an optical flow Op3 is extracted on the basis of the feature points of three-dimensional objects other than the road surface.

Since the algorithm in [online], Keio University, [searched on Mar. 31, 2022], the Internet <URL: http://im-lab.net/artoolkit-overview/> assumes pairs of parallel line segments in a real space, a pair of the optical flows Op1 and Op2 is a correct combination (hereinafter referred to as a “correct flow”) in the attitude estimation. By contrast, for example, a pair of the optical flows Op1 and Op3 is an incorrect combination (hereinafter referred to as a “false flow”).

On the basis of such a false flow, the attitude of the camera 11 cannot be correctly estimated. The rotation angles of the pan, tilt, and roll axes for each of the extracted optical flow pairs are estimated, and, on the basis of a median value of a histogram, axis misalignment of the attitude of the camera 11 is determined. Consequently, the attitude estimation of the camera 11 may be less accurate with more false flows.

To address this, instead of the rectangular ROI 30-1, an ROI 30 is considered to be set in accordance with the shape of the road surface appearing in the captured image. In this case, however, if calibration values (mounting position as well as pan, tilt, and roll) of the camera 11 are not known in the first place, the ROI 30 in accordance with the shape of the road surface (hereinafter referred to as a “road surface ROI 30-2”) cannot be set.

Thus, in the attitude estimation method according to the embodiment, a control unit 15 included in the onboard device 10 (see FIG. 4) performs first attitude estimation processing using the rectangular ROI 30-1 set in a rectangular shape when the camera 11 is in an early stage after mounting, and performs second attitude estimation processing using a superimposed ROI 30-S set in accordance with the shape of the road surface when the camera 11 is not in the early stage after mounting.

Here, being “in the early stage after mounting” refers to a case where the camera 11 is mounted in a “first state”. The “first state” is the state in which the camera 11 is presumed to be in the early stage after mounting. For example, the first state is a state in which the time elapsed since the camera 11 was mounted is less than a predetermined elapsed time. For example, the first state is a state in which a number of calibrations since the camera 11 was mounted is less than a predetermined number of times. For example, the first state is a state in which an amount of misalignment of the camera 11 since the camera 11 was mounted is less than a predetermined amount of misalignment. By contrast, being “not in the early stage after mounting” refers to a case where the camera 11 is mounted in a “second state”, which is different from the first state.

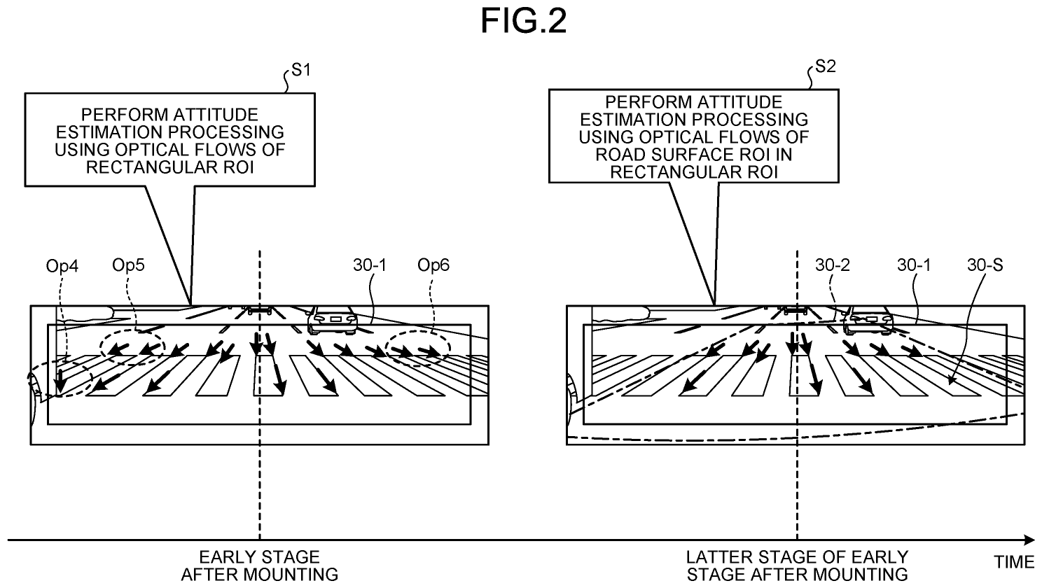

Specifically, as illustrated in FIG. 2, in the attitude estimation method according to the embodiment, when the camera 11 is in the early stage after mounting, the control unit 15 performs the attitude estimation processing using optical flows of the rectangular ROI 30-1 (step S1). When the camera 11 is not in the early stage after mounting, the control unit 15 performs the attitude estimation processing using optical flows of the road surface ROI 30-2 in the rectangular ROI 30-1 (step S2). The road surface ROI 30-2 in the rectangular ROI 30-1 refers to the superimposed ROI 30-S, which is a superimposed portion where the rectangular ROI 30-1 and the road surface ROI 30-2 overlap.

As illustrated in FIG. 2, using the optical flows of the superimposed ROI 30-S results in fewer false flows. For example, optical flows Op4, Op5, and Op6, which are included in the processing target at step S1, are no longer included at step S2.

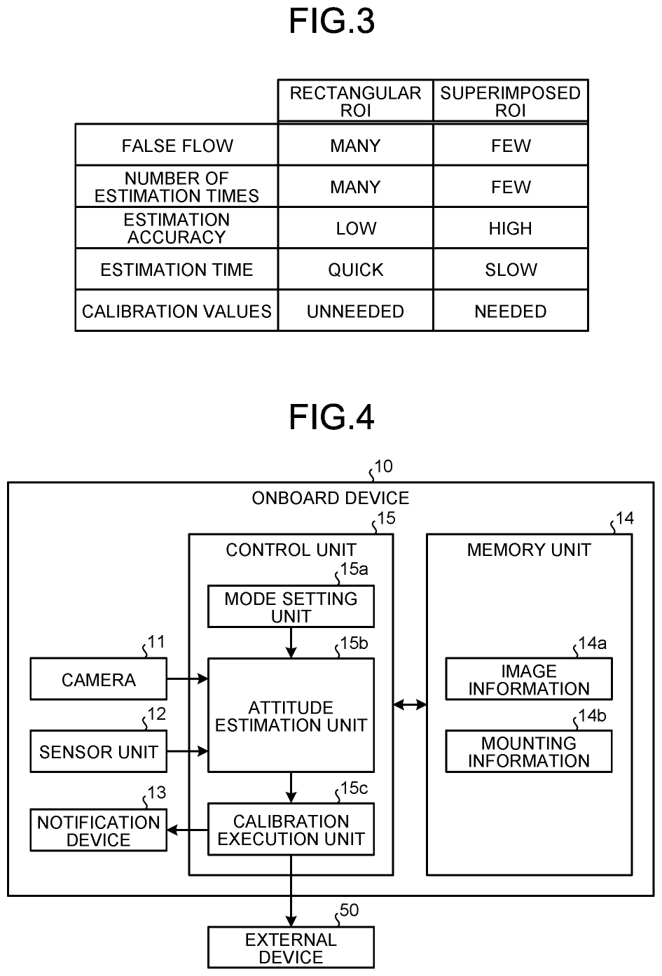

FIG. 3 illustrates a comparison between a case with the rectangular ROI 30-1 and a case with the superimposed ROI 30-S. When the superimposed ROI 30-S is used, there are fewer false flows, a fewer number of estimation times, and higher estimation accuracy than when the rectangular ROI 30-1 is used. However, the estimation time is slow and calibration values are needed.

Nevertheless, those disadvantages of estimation time and calibration values are compensated for by the attitude estimation processing using the rectangular ROI 30-1 being performed when the camera 11 is in the early stage after mounting at step S1.

In other words, with the attitude estimation method according to the embodiment, the accuracy of the attitude estimation of the camera 11 can be improved while respective disadvantages of using the rectangular ROI 30-1 and of using the superimposed ROI 30-S are compensated for by the advantages of the other.

In this manner, in the attitude estimation method according to the embodiment, the control unit 15 performs the first attitude estimation processing using the rectangular ROI 30-1 set in a rectangular shape when the camera 11 is in the early stage after mounting, and performs the second attitude estimation processing using the superimposed ROI 30-S set in accordance with the shape of the road surface when the camera 11 is not in the early stage after mounting.

Therefore, with the attitude estimation method according to the embodiment, the accuracy of the attitude estimation of the camera 11 can be improved.

An example configuration of the onboard device 10 to which the aforementioned attitude estimation method according to the embodiment is applied will be described more specifically below.

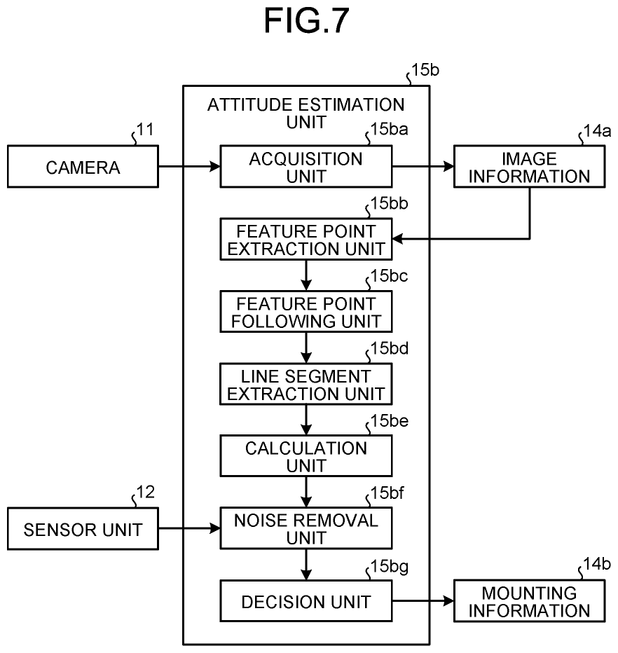

FIG. 4 is a block diagram illustrating the example configuration of the onboard device 10 according to the embodiment. In FIG. 4 and in FIG. 7 to be illustrated later, only the components needed to describe the features of the present embodiment are illustrated, and the description of general components is omitted.

In other words, each of the components illustrated in FIG. 4 and FIG. 7 are functional concepts and do not necessarily have to be physically configured as illustrated. For example, the specific form of distribution and integration of blocks is not limited to that illustrated in the figures, but can be configured by distributing and integrating all or part of the blocks functionally or physically in any units in accordance with various loads and usage conditions.

In the description using FIG. 4 and FIG. 7, components that have already been described may be simplified or omitted.

As illustrated in FIG. 4, the onboard device 10 according to the embodiment has the camera 11, a sensor unit 12, a notification device 13, a memory unit 14, and the control unit 15.

The camera 11 includes an image sensor such as a charge coupled device (CCD) or a complementary metal oxide semiconductor (CMOS), for example, and uses such an image sensor to capture images of a predetermined imaging area. The camera 11 is mounted at various locations on the vehicle, such as the windshield or the dashboard, for example, so as to capture the predetermined imaging area in the front of the vehicle.

The sensor unit 12 is a variety of sensors mounted on the vehicle and includes, for example, a vehicle speed sensor and a G-sensor. The notification device 13 notifies information about calibration. The notification device 13 is implemented by, for example, a display or a speaker.

The memory unit 14 is implemented by a memory device such as random-access memory (RAM) and flash memory. The memory unit 14 stores therein image information 14a and mounting information 14b in the example of FIG. 4.

The image information 14a stores therein images captured by the camera 11. The mounting information 14b is information about mounting of the camera 11. The mounting information 14b includes design values for the mounting position and attitude of the camera 11 and the calibration values described above. The mounting information 14b may further include various information that may be used to determine whether the camera 11 is in the early stage after mounting, such as the date and time of mounting, the time elapsed since the camera 11 was mounted, and the number of calibrations since the camera 11 was mounted.

The control unit 15 is a “controller” and is implemented by, for example, a central processing unit (CPU) or a micro processing unit (MPU) executing a computer program (not illustrated) according to the embodiment stored in the memory unit 14 with RAM as a work area. The control unit 15 can be implemented by an integrated circuit such as an application specific integrated circuit (ASIC) or a field programmable gate array (FPGA).

The control unit 15 has a mode setting unit 15a, an attitude estimation unit 15b, and a calibration execution unit 15c and realizes or performs functions and actions of information processing described below.

The mode setting unit 15a sets an attitude estimation mode, which is the execution mode of the attitude estimation unit 15b, to a first mode when the camera 11 is in the early stage after mounting. The mode setting unit 15a sets the attitude estimation mode of the attitude estimation unit 15b to a second mode when the camera 11 is not in the early stage after mounting.

The attitude estimation unit 15b performs the first attitude estimation processing using the optical flows of the rectangular ROI 30-1, when the execution mode is set to the first mode. The attitude estimation unit 15b performs the second attitude estimation processing using the optical flows of the road surface ROI 30-2 in the rectangular ROI 30-1 (i.e., the superimposed ROI 30-S), when the execution mode is set to the second mode.

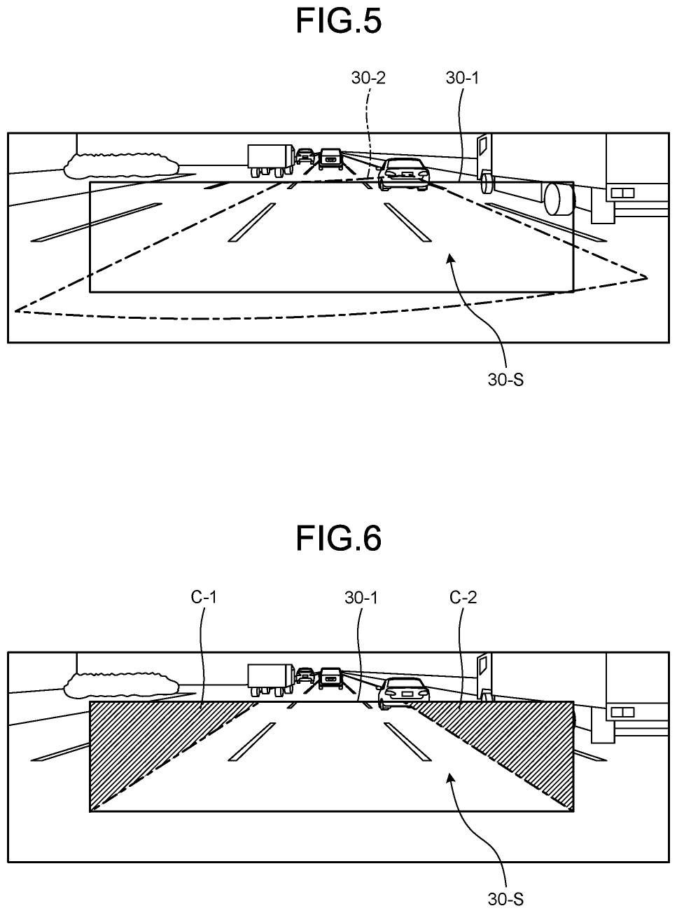

Here, the road surface ROI 30-2 and the superimposed ROI 30-S will be described specifically. FIG. 5 is an illustration (1) of the road surface ROI30-2 and the superimposed ROI30-S. FIG. 6 is also an illustration (2) of the road surface ROI30-2 and the superimposed ROI30-S.

As illustrated in FIG. 5, the road surface ROI 30-2 is set as the ROI 30 in accordance with the shape of the road surface appearing in the captured image. The road surface ROI 30-2 is set on the basis of known calibration values so as to be a region about half a lane to one lane to the left and right from the lane in which the vehicle is traveling and about 20 m deep.

As illustrated in FIG. 5, the superimposed ROI 30-S is a superimposed portion where the rectangular ROI 30-1 and the road surface ROI 30-2 overlap. Expressed more abstractly, the superimposed ROI 30-S can be said to be a trapezoidal region in which an upper left region C-1 and an upper right region C-2 are removed from the rectangular ROI 30-1, as illustrated in FIG. 6. By removing the upper left region C-1 and the upper right region C-2 from the rectangular ROI 30-1 and using the resulting region as a region of interest for attitude estimation processing, false flows can occur less frequently and the accuracy of the attitude estimation can be improved.

An example configuration of the attitude estimation unit 15b will be described more specifically. FIG. 7 is a block diagram illustrating the example configuration of the attitude estimation unit 15b. As illustrated in FIG. 7, the attitude estimation unit 15b has an acquisition unit 15ba, a feature point extraction unit 15bb, a feature point following unit 15bc, a line segment extraction unit 15bd, a calculation unit 15be, a noise removal unit 15bf, and a decision unit 15bg.

The acquisition unit 15ba acquires images captured by the camera 11 and stores the images in the image information 14a. The feature point extraction unit 15bb sets an ROI 30 corresponding to the execution mode of the attitude estimation unit 15b for each captured image stored in the image information 14a. The feature point extraction unit 15bb also extracts feature points included in the set ROI 30.

The feature point following unit 15bc follows each feature point extracted by the feature point extraction unit 15bb across frames and extracts an optical flow for each feature point. The line segment extraction unit 15bd removes noise components from the optical flow extracted by the feature point following unit 15bc and extracts a group of line segment pairs based on the optical flow.

For each of the pairs of line segments extracted by the line segment extraction unit 15bd, the calculation unit 15be calculates rotation angles of the pan, tilt, and roll axes by using the algorithm in [online], Keio University, [searched on Mar. 31, 2022], the Internet <URL: http://im-lab.net/artoolkit-overview/>.

The noise removal unit 15bf removes noise portions due to the low speed and steering angle, of the angles calculated by the calculation unit 15be on the basis of sensor values of the sensor unit 12. The decision unit 15bg makes a histogram of each angle from which the noise portions have been removed, and determines angle estimates for pan, tilt, and roll on the basis of the median values. The decision unit 15bg stores the determined angle estimates in the mounting information 14b.

The description returns to FIG. 4 now. The calibration execution unit 15c performs calibration on the basis of the estimation results by the attitude estimation unit 15b. Specifically, the calibration execution unit 15c compares the angle estimate estimated by the attitude estimation unit 15b with the design value included in the mounting information 14b, and calculates the error.

If the calculated error is within tolerance, the calibration execution unit 15c notifies an external device 50 of the calibration value. The external device 50 is, for example, various devices that implement parking frame detection and automatic parking functions. The phrase “error is within tolerance” refers to the absence of axis misalignment of the camera 11.

If the calculated error is out of tolerance, the calibration execution unit 15c notifies the external device 50 of the calibration value and causes the external device 50 to stop the parking frame detection and automatic parking functions. The phrase “error is out of tolerance” refers to the presence of axis misalignment of the camera 11.

The calibration execution unit 15c also notifies the notification device 13 of the calibration execution results. On the basis of the content of the notification, a user will have the mounting angle of the camera 11 adjusted at a dealer or the like, if necessary.

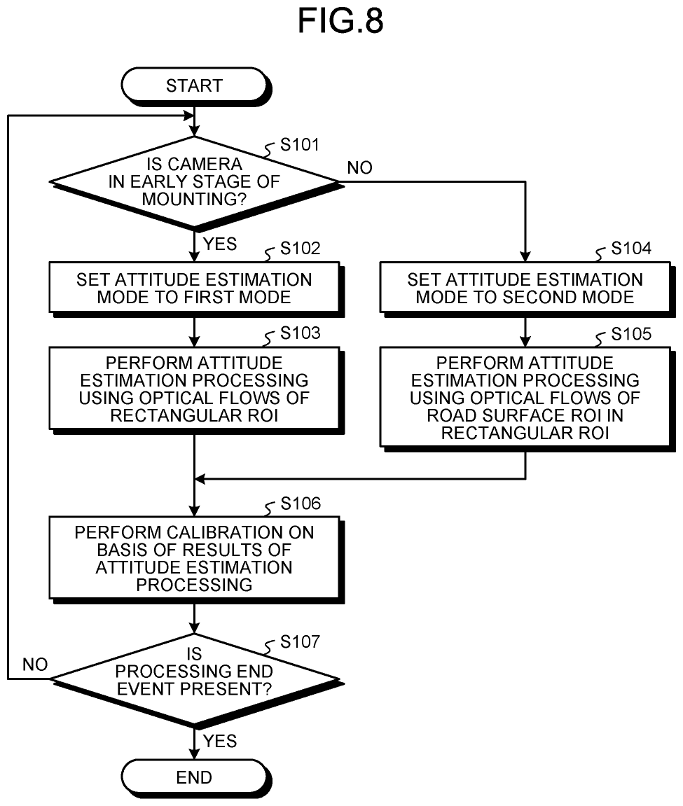

A procedure performed by the onboard device 10 will be described next with reference to FIG. 8. FIG. 8 is a flowchart illustrating the procedure performed by the onboard device 10 according to the embodiment.

As illustrated in FIG. 8, the control unit 15 of the onboard device 10 determines whether the camera 11 is in the early stage after mounting (step S101). If the camera 11 is in the early stage after mounting (Yes at step S101), the control unit 15 sets the attitude estimation mode to the first mode (step S102).

The control unit 15 then performs the attitude estimation processing using the optical flows of the rectangular ROI 30-1 (step S103). If the camera 11 is not in the early stage after mounting (No at step S101), the control unit 15 sets the attitude estimation mode to the second mode (step S104).

The control unit 15 then performs the attitude estimation processing using the optical flows of the road surface ROI 30-2 in the rectangular ROI 30-1 (step S105). The control unit 15 performs calibration on the basis of the results of the attitude estimation processing at step S103 or step S105 (step S106).

The control unit 15 determines whether a processing end event is present (step S107). A processing end event is, for example, the arrival of a non-execution time period for the attitude estimation processing, engine shutdown, or power off. If a processing end event has not occurred (No at step S107), the control unit 15 repeats the procedure from step S101. If a processing end event has occurred (Yes at step S107), the control unit 15 ends the procedure.

As has been described above, the onboard device 10 (corresponding to an example of the “information processing apparatus”) according to the embodiment includes the control unit 15 (corresponding to an example of the “controller”). The control unit 15 performs the attitude estimation processing to estimate the attitude of the camera 11 on the basis of optical flows of feature points in the ROI 30 (corresponding to an example of the “region of interest”) set in the image captured by the camera 11 (corresponding to an example of the “onboard camera”). When the camera 11 is mounted in the first state, the control unit 15 performs the first attitude estimation processing using the rectangular ROI 30-1 (corresponding to an example of a “first region of interest”) set in a rectangular shape, and when the camera 11 is mounted in the second state, the control unit 15 performs the second attitude estimation processing using the superimposed ROI 30-S (corresponding to an example of a “second region of interest”) set in accordance with shape of the road surface.

Therefore, with the onboard device 10 according to the embodiment, the accuracy of the attitude estimation of the camera 11 can be improved.

The control unit 15 performs the second attitude estimation processing using the superimposed ROI 30-S set in a trapezoidal shape.

Therefore, with the onboard device 10 according to the embodiment, false flows can be prevented from occurring, and on the basis of this, the accuracy of the attitude estimation of the camera 11 can be improved.

The control unit 15 sets the superimposed ROI 30-S as the trapezoidal region obtained by removing, from the rectangular ROI 30-1, areas other than the area corresponding to the shape of the road surface that appears to converge toward the vanishing point in the captured image.

Therefore, with the onboard device 10 according to the embodiment, the superimposed ROI 30-S can be set as a region of interest in accordance with the shape of the road surface that appears to converge toward the vanishing point.

The control unit 15 sets the road surface ROI 30-2 (corresponding to an example of a “third region of interest”) in accordance with the shape of the road surface in the captured image on the basis of the calibration values related to the mounting of the camera 11 that become known by performing the first attitude estimation processing, and sets, as the superimposed ROI 30-S, the superimposed portion where the road surface ROI 30-2 and the rectangular ROI 30-1 overlap.

Therefore, with the onboard device 10 according to the embodiment, the accuracy of the attitude estimation of the camera 11 can be improved while respective disadvantages of using the rectangular ROI 30-1 and of using the superimposed ROI 30-S are compensated for by the advantages of the other.

The control unit 15 extracts, from the ROI 30, a group of line segment pairs based on the optical flow, and estimates the rotation angles of the pan, tilt, and roll axes of the camera 11 on the basis of each of the line segment pairs.

Therefore, with the onboard device 10 according to the embodiment, the rotation angles of the pan, tilt, and roll axes of the camera 11 can be estimated with high accuracy on the basis of each of the line segment pairs having few false flows.

The control unit 15 determines the angle estimates for the pan, tilt, and roll axes on the basis of the median value after making a histogram of each of the estimated rotation angles.

Therefore, with the onboard device 10 according to the embodiment, the angle estimates of the pan, tilt, and roll axes can be determined with high accuracy on the basis of median values of the rotation angles estimated with high accuracy.

The control unit 15 determines the axis misalignment of the camera 11 on the basis of the determined angle estimates.

Therefore, with the onboard device 10 according to the embodiment, the axis misalignment of the camera 11 can be determined with high accuracy on the basis of highly accurate angle estimates.

When the axis misalignment is determined, the control unit 15 stops at least one of the parking frame detection function or the automatic parking function.

Therefore, with the onboard device 10 according to the embodiment, operational errors can be prevented from occurring at least in the parking frame detection function or the automatic parking function on the basis of the axis misalignment determined with high accuracy.

The attitude estimation method according to the embodiment is an information processing method performed by the onboard device 10, and includes performing attitude estimation processing to estimate the attitude of the camera 11 on the basis of optical flows of feature points in the ROI 30 set in the image captured by the camera 11. The attitude estimation method according to the embodiment further includes performing first attitude estimation processing using the rectangular ROI 30-1 set in a rectangular shape when the camera 11 is mounted in the first state, and performing second attitude estimation processing using the superimposed ROI 30-S set in accordance with the shape of the road surface when the camera 11 is mounted in the second state.

Therefore, with the attitude estimation method according to the embodiment, the accuracy of the attitude estimation of the camera 11 can be improved.

The computer program according to the embodiment causes a computer to perform attitude estimation processing to estimate the attitude of the camera 11 on the basis of optical flows of feature points in the ROI 30 set in the image captured by the camera 11. The computer program according to the embodiment further causes the computer to perform first attitude estimation processing using the rectangular ROI 30-1 set in a rectangular shape when the camera 11 is mounted in the first state, and to perform second attitude estimation processing using the superimposed ROI 30-S set in accordance with the shape of the road surface when the camera 11 is mounted in the second state.

Therefore, with the computer program according to the embodiment, the accuracy of the attitude estimation of the camera 11 can be improved. The computer program according to the embodiment can be recorded on a computer-readable recording medium, such as a hard disk, a flexible disk (FD), CD-ROM, a magneto-optical disk (MO), a digital versatile disc (DVD), and a universal serial bus (USB) memory, and can be executed by the computer reading from the recording medium. The recording medium in which the program is stored is also one embodiment of the present disclosure.

According to an aspect of the embodiment, the accuracy of the attitude estimation of the onboard camera can be improved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An information processing apparatus comprising:
a controller configured to estimate an attitude of an onboard camera based on an image captured by the onboard camera, wherein
the controller is further configured to:
execute first attitude estimation processing that includes:
setting a rectangular-shaped first region of interest in the captured image;
calculating a first calibration value based on optical flows of feature points in the first region of interest; and
estimating an attitude of the onboard camera; and
execute second attitude estimation processing that includes:
setting, in the captured image, a second region of interest corresponding to a shape of a road surface by using a known calibration value; and
calculating a second calibration value based on optical flows of feature points in the second region of interest; and
estimating an attitude of the onboard camera.

2. The information processing apparatus according to claim 1, wherein the second region of interest is trapezoidal-shaped.

3. The information processing apparatus according to claim 2, the second region of interest has a shape according to a shape of the road surface that appears to converge toward a vanishing point in the captured image.

4. The information processing apparatus according to claim 2, the second attitude estimation processing further includes:
calculating the second calibration value based on optical flows of feature points in a superimposed portion where the first region of interest and the second region of interest overlap; and
estimating an attitude of the onboard camera.

5. The information processing apparatus according to claim 1, wherein the controller is further configured to:
extract, from each of the first region of interest and the second region of interest, a group of line segment pairs based on the optical flows; and
estimate, as the first calibration value and the second calibration value, rotation angles of pan, tilt, and roll axes of the onboard camera based on each of the line segment pairs.

6. The information processing apparatus according to claim 5, wherein the controller determines angle estimates for the pan, tilt, and roll axes based on a median value after making a histogram of each of the estimated rotation angles.

7. The information processing apparatus according to claim 6, wherein the controller determines axis misalignment of the onboard camera based on the determined angle estimates.

8. The information processing apparatus according to claim 7, wherein the controller stops at least one of a parking frame detection function or an automatic parking function when the axis misalignment is determined.

9. An information processing method performed by an information processing apparatus, the information processing method comprising:
acquiring an image captured by an onboard camera;
setting a rectangular-shaped first region of interest in the captured image;
calculating a first calibration value based on optical flows of feature points in the first region of interest; and
estimating an attitude of the onboard camera;
setting, in the captured image, a second region of interest corresponding to a shape of a road surface by using a known calibration value;
calculating a second calibration value based on optical flows of feature points in the second region of interest; and
estimating an attitude of the onboard camera.

10. A computer-readable recording medium having stored therein a program that causes a computer to execute a process, the process comprising:
acquiring an image captured by an onboard camera;
setting a rectangular-shaped first region of interest in the captured image;
calculating a first calibration value based on optical flows of feature points in the first region of interest; and
estimating an attitude of the onboard camera;
setting, in the captured image, a second region of interest corresponding to a shape of a road surface by using a known calibration value;
calculating a second calibration value based on optical flows of feature points in the second region of interest; and
estimating an attitude of the onboard camera.
